(19) United States
(12) Patent Application Publication
(10) Pub. No.: US 2014/0330652 A1
(43) Pub. Date: Nov. 6, 2014

(54) ONLINE ADVERTISING MODEL

(71) Applicant: Joan SANGER, Waterloo (CA)

(72) Inventor: Joan SANGER, Waterloo (CA)

(21) Appl. No.: 14/268,261

(22) Filed: May 2, 2014

Related U.S. Application Data
(60) Provisional application No. 61/818,626, filed on May 2, 2013.

(51) Int. Cl. G06Q 30/02; G06Q 50/00

(52) U.S. Cl. CPC G06Q 30/0269; G06Q 50/01
USPC 705/14.66

(57) ABSTRACT

An advertising system and method is used to advertise services to users of a network depending on identified circumstances of the user. The advertising may be interactive, intervening, passive or requested by the user. The users are part of a network and the advertising system tailors the advertisements towards the needs of a user based on the user's information such as location, future location, career, future career, education or future education.

This application claims the benefit of U.S. Provisional Application No. 61/818,626, filed May 2, 2013.

### FIELD OF THE INVENTION

The present invention relates to an advertising technique used on and/or in a digital communication platform for individuals and/or a network of individuals and/or users to provide advertisements tailored to the user based on the user's circumstances identified by the advertising technique and/or the user.

### DESCRIPTION OF RELATED ART

The prior art includes services directed towards persons communicating with users of a network to provide information or guidance. Some of the shortcomings of prior art in targeted advertising relate to how to address the immediate needs of computer and mobile digital communication device users, especially as they transition to a new locale, area of study or interest, project, or environment. It is an object of the present invention to provide a service that builds a plan as a group of advertisers or a single advertiser, through a social network and/or any electronic and/or digital communication format, and provide a planning template for re-location services, reentry services, transitional services of any kind, and/or enrollment services needed and chosen by the users themselves, also with the optional use of and assistance of live chats with advertisers or other direct communication with the advertisers.

### BRIEF SUMMARY OF THE INVENTION

The invention allows users of a social network and/or any electronic and/or digital communication format to consider services, plans, or products that are tailored to the user by a service that considers resources advertised by a plurality of advertisers. The service is connected to a network and has access to the information users provide on the social network and/or any electronic and/or digital communication format as they work on their educational plans, life transition plans, and/or their career and/or vocational plans. The service develops a collection of plans, services or products offered to the user based on the information the service collects about the user. In one embodiment of the present invention, an advertiser may initiate communication for the user to receive offers. In another embodiment of the present invention, a user may initiate communication for the user to receive offers from the advertisers according to the plan, service, or product developed by the service.

### BRIEF DESCRIPTION OF THE DRAWINGS

FIG. 1 is a block diagram of an exemplary environment for the advertising technique of an embodiment of the present invention.

FIG. 2 illustrates a flowchart of the processing performed by the planning module and advertisers according to an embodiment of the present invention.

FIG. 3 illustrates a flowchart of the processing performed by the planning engine and users according to an embodiment of the present invention.

FIG. 4 is a block diagram showing the processes and software modules of the planning engine of the present invention.

### DESCRIPTION OF THE PREFERRED EMBODIMENT

In the following detailed description, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “an embodiment,” “this embodiment,” “various embodiment” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, storage devices, networks, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

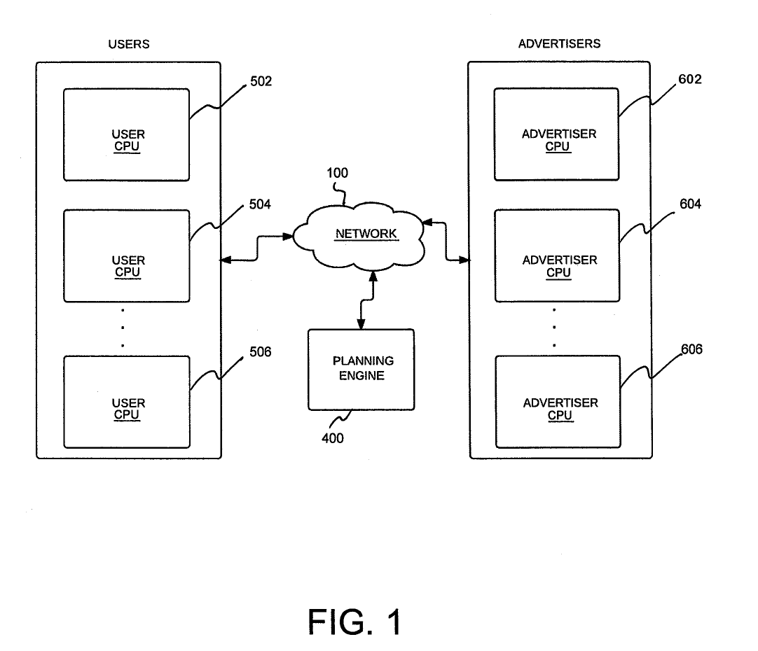

FIG. 1 is a block diagram of an exemplary environment for the advertising technique of an embodiment of the present invention. One or more users, such as a user 502, a user 504, and a user 506, are in communication with a planning engine 400 via a network 100. The users use the planning engine 400 in accordance with the following description. The planning engine 400 connects to social network and/or any electronic and/or digital communication formats via the network 100 and comprises one or more computers or any other device or application capable of providing planning services via the network 100. Hereinafter, the term “social network” refers to a social network, and/or any electronic and/or digital communications format. In other words, the service may be used on a social network, as well as any electronic or digital communications format. The users access the services provided by the planning engine 400 via the network 100. In one embodiment, one or more users may be able to access the planning engine 400 directly.

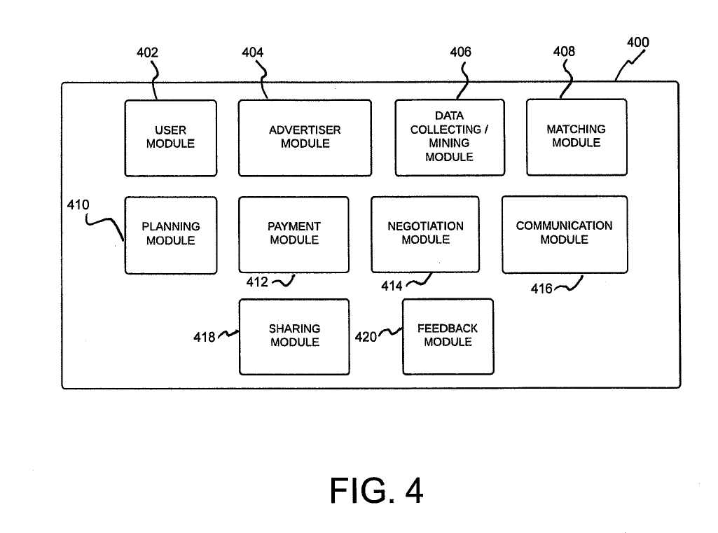

The planning engine 400 is a collection of processes running on a computing device, which includes a processor, memory, I/O interface, and components for connecting to a network 100. The computing device may be server, for example, or a system (software and suitable computer hardware) that responds to requests across a network to provide a network service. The planning engine 400 can be run on a dedicated computer, but many networked computers are capable of hosting servers. In some embodiments, the planning engine 400 provides several services simultaneously to different users and has several servers running. In addition each of the modules (i.e., 402-420 of FIG. 4) within the planning engine, which are explained in more detail below, are software or processes running on the planning engine 400.

Each user is connected to the network using a computing device, which includes a processor, memory, I/O interface, and components for connecting to a network. The computing device may be a server, personal computer, laptop, mobile device, or any other system that incorporates a computing device which can be connected to a social network. The network 100 is the public Internet, an enterprise intranet, or other wide area or local area network.

In one embodiment of the present invention, one or more advertisers such as advertiser 602, advertiser 604, and advertiser 606 connect to the network 100 via computing devices. The advertisers use the planning engine 400 in accordance with the following description. An advertiser may be a person connected to the social network and planning engine 400 or a computer following automated instructions.

The users are part of a social network and/or any electronic communication format. The users display their future plans for education, career, life transition, or the like (hereinafter referred to as “future plans”) on their profile (or personal space), for example, in the social network. The social network is accessed by the users, advertisers, and the planning engine 400. The advertisers create a communication path (which may be a chat line) via the network 100 to target and discuss needs with the users with respect to their future plans. The advertisers have access to the information the users share virtually over the Worldwide Web on the social network 100 as the users continually update their future plans.

In certain instances the user may provide information about their future plans indicating a particular location or enrolling in a particular educational institution, having a life transition or being in need of a particular service at the location or institution identified. In one embodiment, an advertiser of the plurality of advertisers may initiate a communication path using the social network to communicate with the user and offer products or services about the identified location or institution. In another embodiment, the user may initiate a communication path with the advertiser using the social network to communicate with the advertiser and allow the advertiser to offer products or services about the identified location or institution.

In general, the advertisers fulfill needs of the user based on their future plans. The needs are identified, assessed, and evaluated through direct communication, data mining or questionnaires and the like. For example, the advertisers offer services to the users based on their identified needs, life transitions, career or vocational interests, desires, skills, abilities, barriers, and/or activities. The identified needs, interests, skill, abilities, barriers or activities may be identified by referring to the user's information published on the social network. The provider of the network service then optionally offers a personalized service plan of products and services, the user has identified and vetted, for the users to have when and if they re-locate in the area of the educational institution, the needed service and/or product, or job or business startup or purchase or enroll in an educational/training program or resource of any sort.

The network may be a social media network, an independent career or life management network, a communication network consisting of users such as a forum, or a combination of the above. In one embodiment, a user may request an advertiser to obtain the needs once the needs are identified or an advertiser may intervene with the user and offer services or other information detected toward the user's needs. The planning engine has one or more storage devices for storing data. The storage device may be hard drives (HDD), on CD ROMS, in DRAM, and so forth. The planning engine stores other information that can be offered to each user. A user database is created to manage information of each user, which is stored and managed in the planning engine. The user database may store information unique to each user such as published information on a social network. The databases are used by the advertising service and may be hidden from the other users of the network for which the advertising is directed. The advertising service updates the platform or databases and to keep the information current in order to provide accurate advertisements tailored to each user.

In various embodiments, the invention takes what each user is planning to re-locate and/or enroll and/or transition to other areas of life planning or development and personalizes a service plan for the user through the input of advertisers offering local services, such as internet services, cellular services, school and book suppliers, landlords, real estate sellers, food services, health services, life transition services and/or products, counseling services, exercise or gym services, clothing providers, shipping services, moving services, study skills and tutoring programs, language acquisition programs, and banking and other needed services.

One embodiment of the present invention allows advertisers or users, or the network website service that brought them together to create and record their self-identified and otherwise identified needs and come up with an overall services plan for the user. The service plan can include the services of the college, university or educational/training institution as well, such as moving services, schedules for move-ins, key pickups, book purchases and other related educational institution provided services. Information provided can be multilingual.

In various embodiments, Internet searches and/or Internet semantic searches can match the user to the appropriate services and the advertisers be solicited for engagement via online discussion or direct conversation (chat) with the users.

In other embodiments, users have access to static service and advertising data. This data includes the option to engage the advertisers in online discussion or direct conversation to allow the user to choose services and the network that provided the chat or conversation to create a services plan, which can be in multiple languages for the user to be able to understand the needs in his or her new communities for services and how to access those services based on data mined regarding the segmentation of users' needs by industry and/or educational path and/or life plan and/or achievements and/or challenges, and/or challenges.

In various embodiments, users are provided a platform to share their experiences with the local service providers and suggestions to others in the social network for service providers. The platform can engage mentors and/or friends to comment on their experiences with service providers through this social network or other social media forums and connections.

In various embodiments, the data collected from the users of their needs or their experiences with local service providers can be used to create a consumer forum relevant to new users and to be sold to advertisers and/or users and/or other interested parties as well by the social network provider.

Additionally, internal forums with friends on Facebook, LinkedIn and/or other social media forums can be mined for services needed and/or ones that may be assumed to be needed based on the data mined, including in multiple or single languages, and potentially segmented by location, educational institution, life plan, or career plan. Various embodiments include segmentation of users' needs by industry and/or educational path and/or achievements and/or challenges.

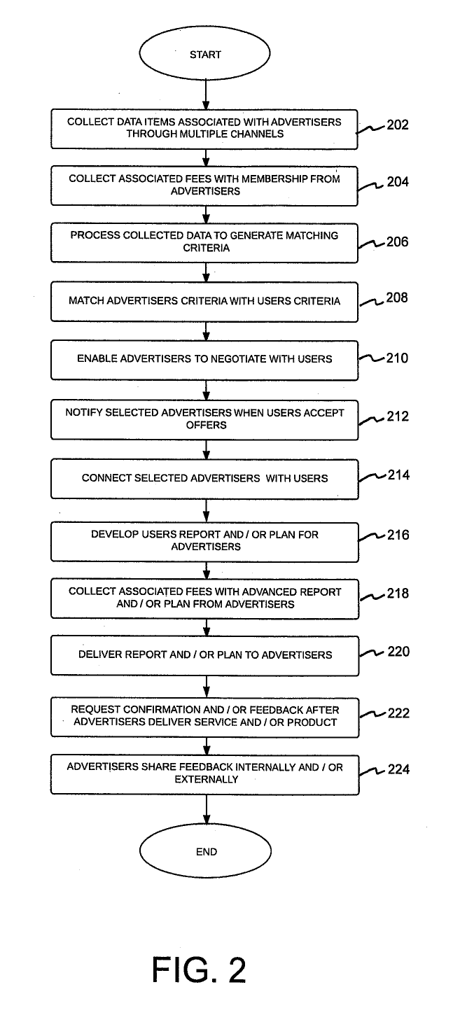

FIG. 2 illustrates a flowchart of the processing performed by the planning engine and advertisers according to an embodiment of the present invention. At step 202, the data collecting/mining module 406 collects data items associated with multiple advertisers connected to the network 100. The data items are stored in a storage device of the planning engine (not shown). Basic data Items include, but are not limited to: company name, address, administrative contact, billing contact, phone, email address, logo, website, social media profile(s), product(s) and/or service(s) name(s), geographic area of service delivery, or payment methods accepted. Advanced data Items collected from an advertiser include, but are not limited to: pricing, special offers including discounts, coupons, other promotional items and give-aways, delivery times, or delivery costs. Additional advanced data collected or mined associated with an advertiser include, but are not limited to: customer satisfaction, user ratings, comparative pricing, number of transactions/services completed, number of transactions/products/services delivered, number of unique customers, or geography of completed transactions. In some embodiments, the basic and advanced data of the advertisers are collected from published information, which the data collecting/mining module 406 evaluates and collects. The information does not need to be published, however, the information may be only known to the planning engine 400.

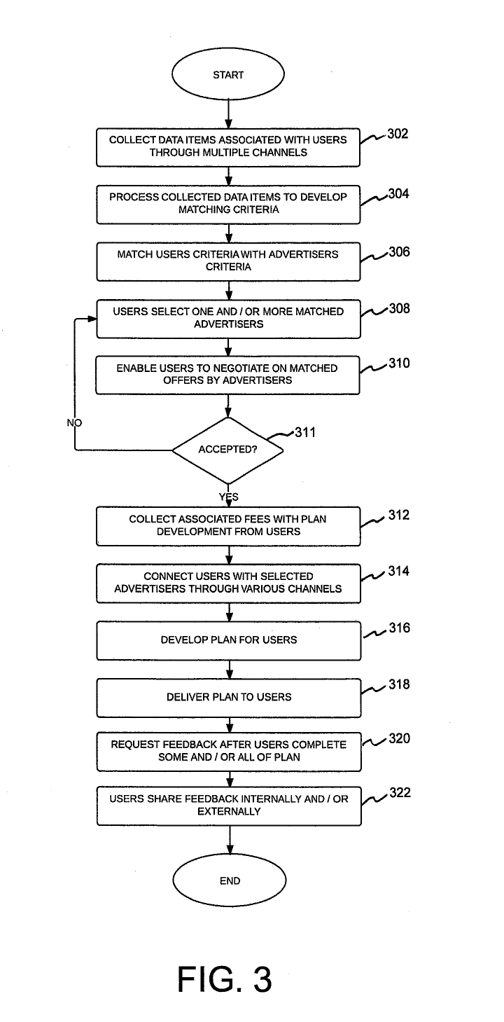

In one embodiment, the planning engine collects fees associated with membership to the planning engine from the advertisers using the advertiser module at 204. Step 204 is performed by payment module 412. At 206, the data items are processed to generate matching criteria of the advertisers. The matching criteria of the advertisers are stored in a storage device of the planning engine. The user criteria, which is published on the social network for each user, is evaluated to determine if there are matches between the matching criteria of the advertisers and the user criteria (in step 208). At steps 302 and 304 of FIG. 3, which is explained below, the user criteria is developed from the data items collected. Once there are matches between the advertisers and users, the matches are stored in a storage device so that they can be later referred to. The matching module performs the processes of step 208.

Subsequently, at 210, the advertisers are enabled to negotiate with the users. Negotiation refers to the ability (enablement) of single or multiple advertiser to deliver offers to the user by the matching module 408, which may be accepted and/or rejected, in whole or in part, by the user. An advertiser receives communication through negotiation module 414 with comments, feedback, refinement and/or other data from a user with specific refinements, or information to improve an offer. An advertiser can select to accept, refine or decline the user request through the negotiation module 414. In one embodiment, advertisers are not able to directly contact users prior to 210. The advertisers refer to the matched users in step 208, to select the users to negotiate with. In one embodiment of the present invention, during the negotiation, the advertisers allow the user to select the advertiser, using the social network interface (e.g., button on social network website) to enable a matched advertiser to send an offer for a product, service, or plan of services or products to the advertiser. The negotiation module performs the processes of negotiating, offering, and notifying selected advertisers when users accept offers (steps 210 and steps 212).

If a user accepts an advertiser to negotiate with, the user allows the advertiser to provide an offer of service, product, or plans for service or product or a combination. If an advertiser is selected by a user, the negotiation module notifies the selected advertiser (step 212). The negotiation module notifies users through one and/or all of the following communication methods as selected by the user, including, but not limited to: e-mail, phone, SMS/text, on-line live chat service, message board, instant messenger, or in-application (web and/or mobile based), if requested through traditional mail such as through a post office. In addition, in one embodiment, the user is notified using the API or platform of the social network by a message or icon notification. At 214, once an advertiser has been selected by the user, the advertiser connects with the user directly using a communication path, (which may or may not have been established in step 210).

At step 216, the planning module 410 develops a user report and/or plan for the advertisers. Based on the data items collected in step 202, the planning module develops the user report or plan for the advertiser. The user report and/or plan uses the information and data collected (in step 202 with step 302) within 208. In one embodiment, the user report and/or plan is developed by the planning module 410 for each user matched. The plan is developed for an advertiser that is matched to a particular user to tailor the advertisement to the user. As a result, the report and/or plan is tailored to the user, so the user may see less than all a particular advertiser has to offer.

Based on the report, the planning engine collects fees associated with a plan from the advertisers, at step 218. The fee is for finding qualified potential buyers or users and/or advanced analytics which may or may not include information such as detailed and/or statistical information about the users and/or competitors weekly, monthly, annually, etc. Subsequently, at step 220, the plan or report is delivered to the advertisers. Then, at step 222, the feedback module 420 requests confirmation and/or feedback after advertisers deliver the service and/or product to the user. The advertiser may share the feedback between other advertisers and over the social network, at step 224. The feedback module and the sharing module perform and coordinate steps 222 and 224, respectively. The feedback module 420 coordinates feedback, which may include negotiations using the negotiation module 414 about the plan or product and may include accepting (by the user) the plan or product. In one embodiment of the present invention, after feedback is completed, the user communicates directly with the advertiser to take advantage of specific products or services offered by the advertiser.

The sharing module 418 coordinates sharing of feedback internally and externally. Internal sharing relates to sharing between users, advertisers and the platform created and externally sharing relates to sharing through digital communication to others outside the participants of the service.

FIG. 3 illustrates a flowchart of the processing performed by the planning engine and users according to an embodiment of the present invention. The data collecting/mining module 406 collects data items associated with users through multiple channels, at step 202. Basic data Items include, but are not limited to: Legal Name, Address, Date of Birth, Gender, Relationship Status, Living Situation, Income, Level of Education, Educational Institutions, Phone, email address, website, social media profile(s), or geographic area of service requested. Advanced data items collected from a user can include, but are not limited to: Work Status, Employer, Employment History, Skills, Certifications, Volunteer History, Personal Challenges, Life Events, or Planned Life Events. Additional advanced data collected or mined associated with a user includes, but is not limited to: number of transactions/services completed, Number of transactions/products/services ordered, or geography of completed transactions. As mentioned above, the basic and advanced data may exist on the user's profile (personal space) of a social network. Multiple channels include, but are not limited to: communication methods as selected by the user, including, but not limited to e-mail, phone, SMS/text, on-line live chat service, message board, instant messenger, in-application (web and/or mobile based), and if requested through traditional mail such as through post office. The data items are stored in a storage device of the planning engine (not shown).

The data items are processed using the matching module 408 to develop matching criteria of the users, at step 304. The matching criteria of the users is stored in a storage device of the planning engine. Subsequently, at step 306, the matching module 408 matches criteria of the users with the matching criteria of the advertisers, which is known and stored by the planning engine (see steps 202 and 206). In one embodiment, the matching criteria of the advertisers is stored independently in a storage device of the planning engine 400 and is updated periodically. In addition, updates of criteria may be pushed or pulled from advertisers subscribed to the service provided by the planning engine 400. Once there are matches between the advertisers and users, the matches are stored in a storage device so that they can be referred to. Once the matches are generated, the users are notified by the user module 402 and communication module 416 using notification means and methods discussed above.

At step 308, by referring to the stored matches, the user may select one or more advertisers matched to the user that receives indication of a match. The user selects the advertisers by selecting them from a list provided by the user module 402 on the social network interface. Users refine and/or select advertisers through one and/or more user interface criteria; the interface may include, but is not limited to: radio button/check-box, button, dropdown list, etc.

Subsequently, at step 310, the users are enabled to negotiate with the matched advertisers. In particular, the negotiation module 414 enables users to select and receive product(s) and/or service(s) that meets their requirements and/or needs. The negotiation module notifies a user through one and/or all of the following communication methods as selected by the user, including but not limited to: e-mail, phone, SMS/text, on-line live chat service, message board, instant messenger, in-application (web and/or mobile based), and if requested through traditional mail such as through post office.

In one embodiment of the present invention, during the negotiation, the advertisers allow the user to select the advertiser, using the social network interface (e.g., button on social network website) to receive an offer of a product, service, or plan of services or products from the advertiser. If a user accepts, (yes in step 311), the user allows the advertiser to provide an offer for a service, product, or plans for a service or product or a combination.

If a user accepts an advertiser to receive information from, at step 312, the platform generates and collects the associated fees with plan development from users. In one embodiment of the present invention, the service fee relates to a fee to the user, which may or may not be collected, or may be free (i.e., no fee or discounted fee). User fees may or may not include monetary compensation and/or collection of data and/or rewards.

Subsequently, at step 314, the user and the advertiser are connected via a communication path. As mentioned above, the communication path may be an indirect or direct connection using or not using the social network and/or any electronic and/or digital communication format API, or platform. Once connected, the planning engine module 410, at step 316, develops a plan or the users based on information collected from the user. The user plan is a partial or complete series of steps, solutions, and/or product(s)/service(s) along with dates, times and locations of any appointments with matched and selected users and advertisers. The plan can help address relevant issues and find resources—people and information—needed for a successful transition. An example of information is the dates and needs of bedding for the user and the chosen advertiser.

At step 318, the plan developed for each user is delivered to the user using the established communication line using the communication module 416. After receiving the plan, the feedback module 420 may request feedback on behalf of the advertisers about the plan a user received. In addition, the sharing module 418 coordinates sharing of feedback internally and externally. Wherein, internal sharing relates to sharing between users, advertisers and the platform created and externally sharing relates to sharing through digital communication to others outside the participants of the service.

FIG. 4 is a block diagram showing the processes and software modules of the planning engine of the present invention. A user module 402 includes a communications interface and processes for receiving data from and sending data to the advertisers and for communicating and evaluating other users (for collecting data items, for example). An advertising module 404 includes a communications interface and processes performed for receiving data from and sending data to the users and for communicating and evaluating other advertisers (for collecting data items, for example). The user module 402 and the advertising module 404 use the communication module 416 for communication over the network 100.

The data collecting/mining module 406 handles the process of collecting data items by scanning information provided by the users and advertisers, questionnaires, and data mining. The matching module 408 performs the process of matching user criteria and advertiser's criteria. The matches are stored in a storage device in a manner (e.g., table or index) that allows the planning engine 400 to refer to the matches to identify matched users or advertisers. The planning module 410 executes processes for creating plans based on the user's needs and what an advertiser has available. The planning module 410 considers resources advertised by the advertiser and the user's data to formulate one or more plans which are used by the user. The planning module 410 also identifies the services or products that are to be offered to a user based on the user's data and the resources advertised by the advertiser.

The payment module 412 consists of a payment gateway for all fees, membership, finder type fees, or transactional. The negotiation module 414 performs the processing that controls whether a user is enabled to negotiate with an advertiser and whether an advertiser is able to negotiate to with a user. The sharing module 418 and feedback module 420 coordinate sharing and feedback, respectively, between users and advertisers, internally and externally to the network 100. The sharing module coordinates internal sharing between users, advertisers and the platform created and external sharing through digital communication. Feedback module 420 enables users to review and/or rate products and/or services. Also, it is enabling advertisers to review and/or rate users.

It should be further understood by those skilled in the art that although the foregoing description has been made on embodiments of the invention, the invention is not limited thereto and various changes and modifications may be made without departing from the spirit of the invention and the scope of the appended claims.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the present invention has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

I claim:

1. A method of connecting a service provider with a user of a social network, wherein users and the service provider are connected through the social network and the users allow information provided by the users to be viewed by other users and the service provider, the method comprising the steps of:
collecting, by the service provider, information provided by the user and identifying, by the service provider, a user in need of a service offered by the service provider based on the information provided by the user;
creating a personalized service, by the service provider, based on the information of the user collected by the service provider;
initiating, by the service provider, a communication link between the service provider and the identified user; and
offering, by the service provider, the personalized service to the identified user using the communication link.

2. The method of connecting a service provider with a user of a social network of claim 1, wherein
the service provider allows information provided by the service provider to be viewed by the users of the social network.

3. The method of connecting a service provider with a user of a social network of claim 1, wherein
the personalized service offered by the service provider is a personalized service plan.

4. The method of connecting a service provider with a user of a social network of claim 1, wherein
the personalized service offered is offering a product to the user.

5. The method of connecting a service provider with a user of a social network of claim 1, wherein
the information provided by the user is information indicating a career or educational goal of the user.

6. The method of connecting a service provider with a user of a social network of claim 1, further comprising the step of:
receiving, by the service provider, a response from the identified user through the network after the offering, by the service provider, the personalized service to the identified user using the communication link.

7. The method of connecting a service provider with a user of a social network of claim 1, wherein
the communication link initiated by the service provider may be initiated through a network other than the social network.

8. The method of connecting a service provider with a user of a social network of claim 1, the method further comprising the steps of:
collecting information judged to be relevant to the service provider, by the service provider, and storing the collected information in a database managed by the service provider.

9. The method of connecting a service provider with a user of a social network of claim 1, wherein
the information provided by the user includes location information and the service provider identifies a user and creates a personalized service based on the location information.

10. The method of connecting a service provider with a user of a social network of claim 1, wherein
the communication link is a chat line using the social network.

11. The method of connecting a service provider with a user of a social network of claim 1, wherein
the personalized service is created based on responses in a questionnaire provided to the identified user by the service provider.

12. The method of connecting a service provider with a user of a social network of claim 1, wherein
the step of identifying the user includes:
collecting, by the service provider, information of a plurality of users on the social network judged to be relevant to the service provider and storing the collected information in a database managed by the service provider, and searching the database for a user in need of a service offered by the service provider based on the information in the database, and
the personalized service is created based on the information in the database.

13. The method of connecting a service provider with a user of a social network of claim 1, wherein
the user is identified by interacting with the user through the communication link.

14. The method of connecting a service provider with a user of a social network of claim 1, wherein
the information includes career interests, skills, barriers, or activities of a user.

15. The method of connecting a service provider with a user of a social network of claim 1, wherein
the personalized service is a gift.

16. A method of connecting a user of a plurality of users of a social network with an advertiser of a plurality of advertisers, wherein users and the advertiser are connected to a planning service through the social network, and the users allow information provided by the users to be viewed by other users and the planning service, the method comprising the steps of:
collecting, by the planning service, information provided by each user, and collecting, by the planning service, information provided by each advertiser;
developing, by the planning service, matching criteria of each advertiser, and developing, by the planning service, matching criteria of each user;
matching, by the planning service, users and advertisers based on the matching criteria;
developing, by the planning service, a personalized plan for a matched user, for each advertiser matched to a user, based on the information collected from the user and information collected from the advertiser matched to the user;
delivering, by the planning service, the personalized plan to each user for each advertiser; and
receiving feedback, by the planning service, from users with respect to the personalized plan.

17. A method of connecting a user of a social network with an advertiser of claim 16, wherein
the information provided by the user is information indicating a career or educational goal of the user.

18. A method of connecting a user of a social network with an advertiser of claim 16, the method further comprising the steps of:
collecting information judged to be relevant to the service provider of the user that initiated the communication link, by the service provider, and storing the collected information in a database managed by the service provider.

19. A method of connecting a user of a social network with an advertiser of claim 16, wherein
the information includes career interests, skills, barriers, or activities of a user.

20. A method of connecting a user of a plurality of users of a social network with an advertiser of a plurality of advertisers, wherein users and the advertiser are connected to a planning service through the social network, and the users allow information provided by the users to be viewed by other users and the planning service, the method comprising the steps of:
collecting, by the planning service, information provided by each user, and collecting, by the planning service, information provided by each advertiser;
developing, by the planning service, matching criteria of each advertiser, and developing, by the planning service, matching criteria of each user;
matching, by the planning service, users and advertisers based on the matching criteria;
selecting, by the advertiser, users to negotiate from the users matched to the advertiser;
accepting, by the user, an advertiser to negotiate with;
notifying, by the planning service, an advertiser, the user accepts to negotiate with;
developing, by the planning service, a personalized plan for a matched user, for each advertiser matched to a user, based on the information collected from the user and information collected from the advertiser matched to the user;
delivering, by the planning service, the personalized plan to the advertiser;
delivering, by the advertiser, the personalized plan to the user matched with the advertiser; and
receiving, by the planning service, feedback from users with respect to the personalized plan.
